(19) United States
(12) Patent Application Publication
(10) Pub. No.: US 2022/0050358 A1
(43) Pub. Date: Feb. 17, 2022

(54) DRIVING DEVICE, CAMERA MODULE AND ELECTRONIC DEVICE

(71) Applicant: LARGAN DIGITAL CO., LTD., Taichung City (TW)

(72) Inventors: Lin-An CHANG, Taichung City (TW); Ming-Ta CHOU, Taichung City (TW); Chen-Yi HUANG, Taichung City (TW); Ming-Shun CHANG, Taichung City (TW)

(21) Appl. No.: 17/338,753

(22) Filed: Jun. 4, 2021

Related U.S. Application Data
(60) Provisional application No. 63/064,997, filed on Aug. 13, 2020.

(51) Int. Cl. G03B 13/36; G03B 5/04

(52) U.S. Cl. CPC G03B 13/36; G03B 2205/0069; G03B 2205/0015; G03B 5/04

(57) ABSTRACT

A driving device has a central axis and includes a cover, a base, at least one displaceable holder and at least one translational auxiliary member. The cover surrounds the central axis and is fixed to the base for forming a containing space. The displaceable holder is disposed in the containing space and includes at least one horizontal rolling member. The horizontal rolling member is provided that renders the displaceable holder displaceable relatively to the cover and the base along at least one direction perpendicular to the central axis. The translational auxiliary member abuts against the cover and the displaceable holder. The translational auxiliary member and the horizontal rolling member are disposed on two opposite sides along the central axis, respectively.

### RELATED APPLICATIONS

This application claims priority to U.S. Provisional Application Ser. No. 63/064,997, filed Aug. 13, 2020, which is herein incorporated by reference.

### BACKGROUND

### Technical Field

The present disclosure relates to a driving device and a camera module. More particularly, the present disclosure relates to a driving device and a camera module applicable to electronic devices.

### Description of Related Art

In recent years, portable electronic devices, such as intelligent electronic devices, tablets, etc., are developed rapidly and have been filled with the lives of modern people. Accordingly, a camera module and a driving device thereof disposed on the portable electronic device are also flourished. However, as technology is more and more advanced, demands for the quality of the imaging lens module of users have become higher and higher. Therefore, developing the driving device with miniaturization and stabilizing displaceable directions of the image lens assembly becomes a solving problem in industry.

### SUMMARY

According to one aspect of the present disclosure, a driving device has a central axis and includes a cover, a base, at least one displaceable holder and at least one translational auxiliary member. The cover surrounds the central axis and is fixed to the base for forming a containing space. The displaceable holder is disposed in the containing space and includes at least one horizontal rolling member. The horizontal rolling member is provided that renders the displaceable holder displaceable relatively to the cover and the base along at least one direction perpendicular to the central axis. The translational auxiliary member abuts against the cover and the displaceable holder. The translational auxiliary member and the horizontal rolling member are disposed on two opposite sides along the central axis, respectively.

According to one aspect of the present disclosure, a camera module includes the aforementioned driving device, an imaging lens element set and an image sensor. The imaging lens element set is disposed on the driving device. The driving device is provided that renders the imaging lens element set displaceable along a direction perpendicular to the central axis and a direction parallel to the central axis. The image sensor is for converting a light passing through the imaging lens element set into an image signal.

According to one aspect of the present disclosure, an electronic device includes the at least one aforementioned camera module.

According to another aspect of the present disclosure, a camera module includes a cover, a base, an imaging lens assembly and at least one horizontal rolling member. The cover is fixed to the base for forming a containing space. The imaging lens assembly is disposed in the containing space, and has an optical axis. The horizontal rolling member is disposed between the imaging lens assembly and the base, and provided that renders the imaging lens assembly displaceable relatively to the cover and the base along at least one direction perpendicular to the central axis. The cover provides a normal force acting on the horizontal rolling member, and a direction of the normal force is parallel to the optical axis of the imaging lens assembly.

### BRIEF DESCRIPTION OF THE DRAWINGS

The present disclosure can be more fully understood by reading the following detailed description of the embodiment, with reference made to the accompanying drawings as follows:

FIG. 1A is an exploded schematic view of a camera module according to the 1 st embodiment of the present disclosure.

FIG. 1B is a three-dimensional schematic view of the combination of the imaging lens assembly and the driving device according to the 1 st embodiment in FIG. 1A.

FIG. 1C is a perspective schematic view of the cover according to the 1 st embodiment in FIG. 1A.

FIG. 1D is a three-dimensional schematic view of the cover according to the 1 st embodiment in FIG. 1A.

FIG. 1E is another three-dimensional schematic view of the cover according to the 1 st embodiment in FIG. 1A.

FIG. 1F is a schematic view of parameters of the camera module according to the 1 st embodiment in FIG. 1A.

FIG. 2A is an exploded schematic view of a camera module according to the 2 nd embodiment of the present disclosure.

FIG. 2B is a three-dimensional schematic view of the cover according to the 2nd embodiment in FIG. 2A

FIG. 2C is another three-dimensional schematic view of the cover according to the 2 nd embodiment in FIG. 2A.

FIG. 2D is a schematic view of parameters of the camera module according to the 2 nd embodiment in FIG. 2A.

FIG. 3A is an exploded schematic view of a camera module according to the 3 rd embodiment of the present disclosure.

FIG. 3B is a three-dimensional schematic view of the cover according to the 3 rd embodiment in FIG. 3A.

FIG. 3C is another three-dimensional schematic view of the cover according to the 3 rd embodiment in FIG. 3A.

FIG. 3D is a schematic view of parameters of the camera module according to the 3 rd embodiment in FIG. 3A.

FIG. 4A is a schematic view of an electronic device according to the 4 th embodiment of the present disclosure.

FIG. 4B is a block diagram of the electronic device according to the 4 th embodiment in FIG. 4A.

FIG. 4C is a schematic view of a selfies scene according to the 4 th embodiment in FIG. 4A.

FIG. 4D is a schematic view of an image according to the 4 th embodiment in FIG. 4A.

### DETAILED DESCRIPTION

The present disclosure provides a driving device which has a central axis and includes a cover, a base, at least one displaceable holder and at least one translational auxiliary member. The cover surrounds the central axis and is fixed to the base for forming a containing space. The displaceable holder is disposed in the containing space and includes at least one horizontal rolling member. The horizontal rolling member is provided that renders the displaceable holder displaceable relatively to the cover and the base along at least one direction perpendicular to the central axis. The translational auxiliary member abuts against the cover and the displaceable holder. The translational auxiliary member and the horizontal rolling member are disposed on two opposite sides along the central axis, respectively. Via the design of the translational auxiliary member and the cover, the prepressing against the displaceable holder can be provided properly so as to prevent the horizontal rolling member from loosened, which is favorable for providing the displaceable degrees of freedom on two-dimensional surface and achieving miniaturization.

The cover can provide a normal force acting on the displaceable holder and the horizontal rolling member via the translational auxiliary member, wherein a direction of the normal force is perpendicular to a displaceable direction of the holder. Hence, the normal force can keep the displaceable holder and the horizontal rolling member remaining on a displaceable surface for stabilizing the displaceable direction.

The cover can include an opening portion, a fixing portion and a receiving portion. The opening portion surrounds the central axis and forms an opening. The fixing portion extends from the opening portion to the base and fixed to the base. The receiving portion is disposed between the opening portion and the fixing portion, and for receiving the translational auxiliary member. Hence, via the design of the receiving portion, the structural strength of the cover can be improved and manufacturing tolerance of the cover can be decreased. Moreover, the fixing portion of the cover can be connected and fixed to the base via glue adhesion or welding, but the present disclosure is not limited thereto.

The receiving portion can include two step surfaces. The two step surfaces are parallel to each other and receive the at least two translational auxiliary members. Hence, the structure of the cover can be designed more elaborately so that the stress between the cover and the translational auxiliary member is well-distributed. Specifically, the two step surfaces can be corresponding to two horizontal rolling members which roll along different dimensions, respectively.

The receiving portion can receive the at least one translational auxiliary member by a point contacting method. Hence, the friction between the cover and the translational auxiliary member can be reduced so as to improve the driving quality.

The driving device can further include at least one groove. The groove can be disposed on at least one of the displaceable holder and the cover, and the translational auxiliary member is disposed in the groove. Hence, the displaceable holder and the cover can be prevented from the strong impact by the translational auxiliary member so as to improve product reliability.

The translational auxiliary member can be a ball or a cylinder, but the present disclosure is not limited thereto. When the translational auxiliary member is a ball, it is convenient for assembling so as to improve the assembling efficiency; when the translational auxiliary member is a cylinder, the stronger structural design can be provided, and the stability of the displaceable direction can be remained.

The translational auxiliary member can be disposed symmetrically along the central axis. Hence, tilting during assembling can be prevented.

The driving device can further include a carrier which is disposed in the containing space. The carrier can include at least one axial rolling member. The axial rolling member is provided that renders the carrier displaceable relatively to the displaceable holder along a direction parallel to the central axis. Hence, the axial displaceable degrees of freedom can be provided for achieving three-axial translation of the whole driving device. Moreover, the displaceable holder can include a first displaceable holder and a second displaceable holder. The horizontal rolling member can be disposed between the first displaceable holder and the second displaceable holder, or can also be disposed between the base and the first displaceable holder. The cover can be used to restrict the displaceable region of the displaceable holder (the first displaceable holder and the second displaceable holder) and the carrier.

The cover can overlap at least one part of the axial rolling member along the direction parallel to the central axis. Hence, the cover can prevent the axial rolling member from loosened and remains the carrier displaceable in a specific region.

Specifically, the axial rolling member can be closer to the central axis than the translational auxiliary member to the central axis. Hence, compactness of the structure can be improved so as to avoid the condition of the unbalanced force during the axial movement.

The cover can be made of at least one of plastic material and metal material. Hence, the cover with high structural strength and high size accuracy can be provided, and the higher producing efficiency can be promoted. In detail, the cover can be a plastic cover via injection molding, a plastic cover with an inserted metal element via insert molding, or a plastic cover coated in a metal layer via laser direct structuring. The cover can also be a metal cover via stamping molding.

The cover can further include at least two gate traces so as to improve the molding efficiency and decrease the molding tolerance.

The driving device can further include at least one driving magnet and at least one driving coil. The driving magnet is disposed on one of a carrier and the displaceable holder, and the driving coil is fixed to the cover and corresponding to the driving magnet. Hence, the electromagnetic driving force can be provided for achieving stability of the optical image and auto focusing. Specifically, a number of the driving magnet can be two, and the two driving magnets can be disposed on the carrier and the displaceable holder, respectively. The driving coil can include two horizontal driving coils and at least one axial driving coil. The two horizontal driving coils are corresponding to the two driving magnets, respectively. Hence, the displaceable holder can be driven to move along directions perpendicular to the central axis. The axial driving coil can be fixed on the cover and corresponding to the driving magnet which is disposed on the carrier. Hence, the carrier can be driven to move along the central axis.

Each of the abovementioned features of the driving device module can be utilized in various combinations for achieving the corresponding effects.

The present disclosure provides a camera module. The camera module includes the aforementioned driving device, an imaging lens element set and an image sensor. The imaging lens element set is disposed on the driving device. The driving device is provided that renders the imaging lens element set displaceable along a direction perpendicular to the central axis and a direction parallel to the central axis. The image sensor is for converting a light passing through the imaging lens element set into an image signal. Hence, it is favorable for achieving miniaturization.

The present disclosure provides an electronic device. The electronic device includes the at least one aforementioned camera module. Hence, it is favorable for providing the miniature electronic device.

The present disclosure provides another camera module. The camera module includes a cover, a base, an imaging lens assembly and at least one horizontal rolling member. The cover is fixed to the base for forming a containing space. The imaging lens assembly is disposed in the containing space, and has an optical axis. The horizontal rolling member is disposed between the imaging lens assembly and the base, and provided that renders the imaging lens assembly displaceable relatively to the cover and the base along at least one direction perpendicular to the central axis. The cover provides a normal force acting on the horizontal rolling member, and a direction of the normal force is parallel to the optical axis of the imaging lens assembly. Via the design of the cover, the prepressing against the horizontal rolling member is provided properly so as to prevent the horizontal rolling member from loosened, which is favorable for stabilizing a displaceable direction of the imaging lens assembly, and achieving miniaturization.

According to the above description of the present disclosure, the following specific embodiments are provided for further explanation.

### <1 st Embodiment>

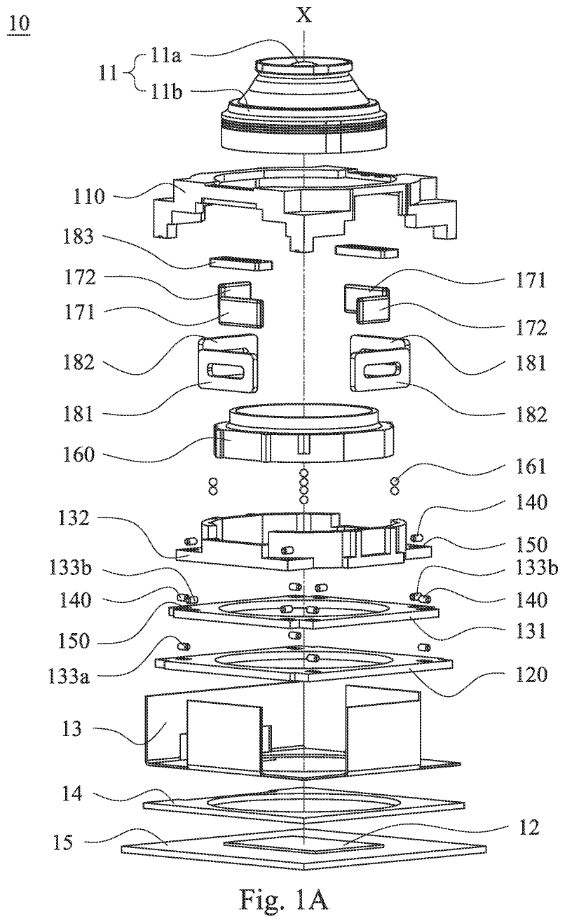

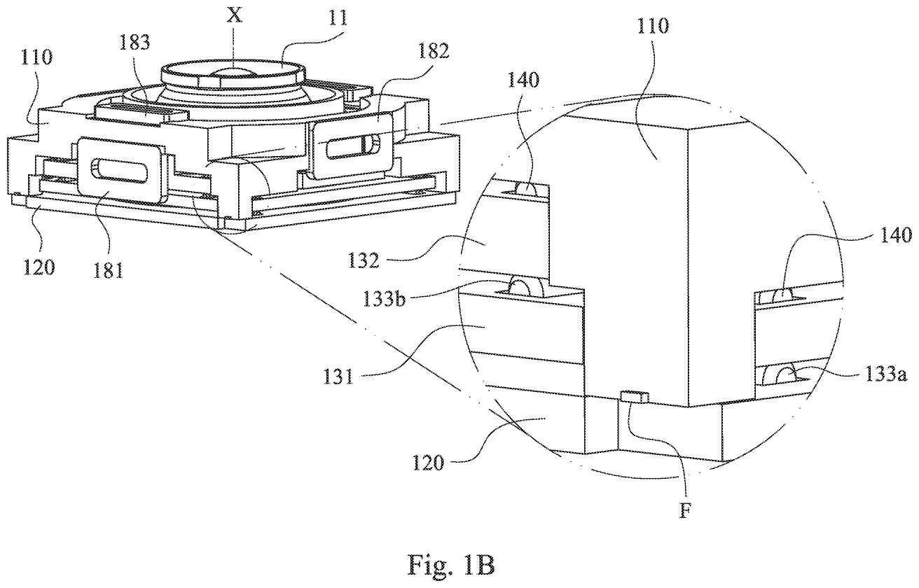

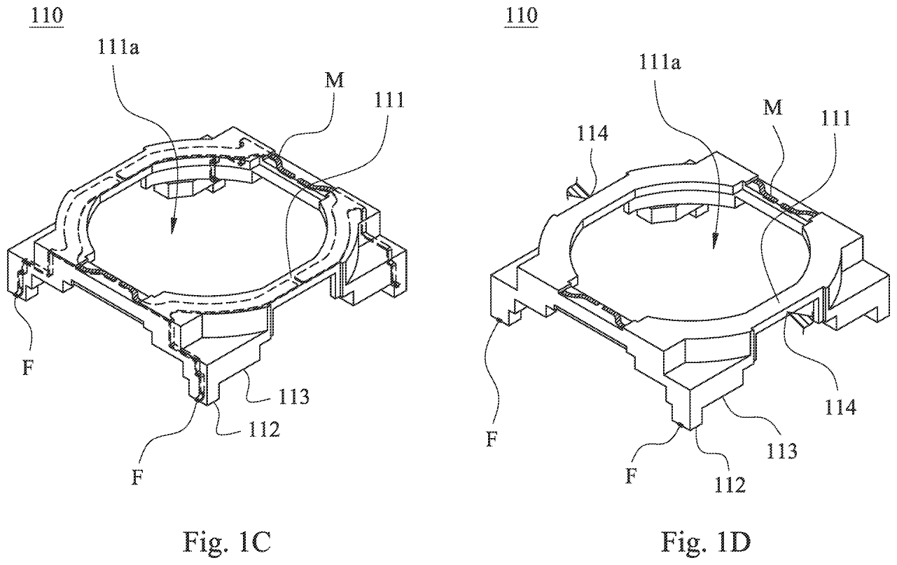

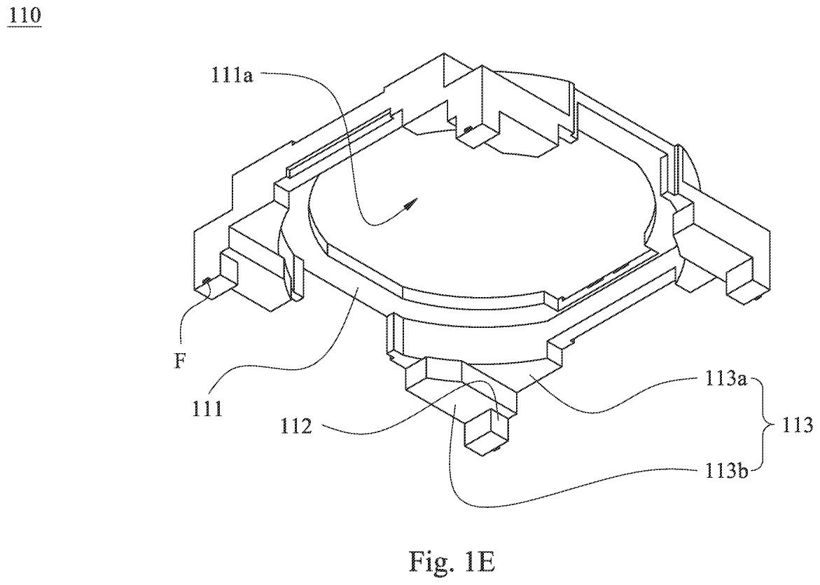

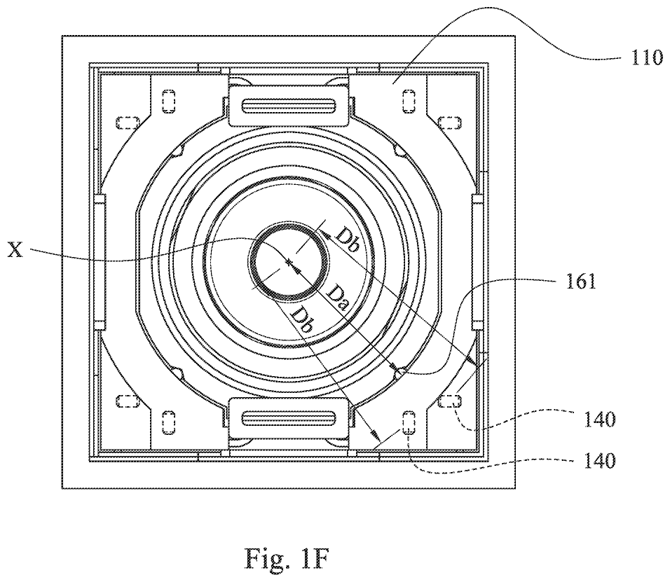

FIG. 1A is an exploded schematic view of a camera module 10 according to the 1 st embodiment of the present disclosure. In FIG. 1A, the camera module 10 includes a driving device (its numeral reference is omitted), an imaging lens assembly 11, an image sensor 12, a driving circuit board 13, a substrate 14 and a circuit board 15. The image lens assembly 11 is disposed in the driving device. The driving circuit board 13, the substrate 14 and the circuit board 15 are arranged in order from a top to a bottom and disposed on the driving device. The image sensor 12 is disposed on the circuit board 15. The driving device has a central axis X and includes a cover 110, a base 120, at least one displaceable holder (its numeral reference is omitted), at least one translational auxiliary member 140, at least one groove 150, a carrier 160, at least one driving magnet (its numeral reference is omitted) and at least one driving coil (its numeral reference is omitted). The imaging lens assembly 11 includes an imaging lens element set 11 a and a lens barrel 11b. The imaging lens element set 11 a is disposed in the lens barrel 11b, and the imaging lens assembly 11 is disposed in a containing space (its numeral reference is omitted) formed by the cover 110 and the base 120. In detail, the driving device is provided that renders the imaging lens element set 11 a displaceable along a direction perpendicular to the central axis X (that is, an optical axis of the imaging lens assembly 11) and a direction parallel to the central axis X. The image sensor 12 is for converting a light passing through the imaging lens element set 11 a into an image signal.

FIG. 1B is a three-dimensional schematic view of the combination of the imaging lens assembly 11 and the driving device according to the 1 st embodiment in FIG. 1A. In FIGS. 1A and 1B, the cover 110 surrounds the central axis X and is fixed to the base 120. The displaceable holder is disposed in the containing space and includes at least one horizontal rolling member (its numeral reference is omitted). The horizontal rolling member is provided that renders the displaceable holder displaceable relatively to the cover 110 and the base 120 along at least one direction perpendicular to the central axis X. The translational auxiliary member 140 abuts against the cover 110 and the displaceable holder. The translational auxiliary member 140 and the horizontal rolling member are disposed on two opposite sides along the central axis X, respectively. Hence, the displaceable degrees of freedom on two-dimensional surface can be provided. Furthermore, tilting during assembling can be prevented via the translational auxiliary member 140 disposed symmetrically along the central axis X. In the 1 st embodiment, the displaceable holder can include a first displaceable holder 131 and a second displaceable holder 132, and the horizontal rolling member can include at least one first horizontal rolling member 133a and at least one second horizontal rolling member 133b. A number of the first horizontal rolling member 133a is four, and the first horizontal rolling members 133a are cylinders and disposed between the base 120 and the first displaceable holder 131. A number of the second horizontal rolling member 133b is four, and the second horizontal rolling members 133b are cylinders and disposed between the first displaceable holder 131 and the second displaceable holder 132, but the present disclosure is not limited thereto.

Moreover, the cover 110 can be used to restrict the displaceable region of the first displaceable holder 131 and the second displaceable holder 132. Via the design of the translational auxiliary member 140 and the cover 110, the prepressing against the first displaceable holder 131 and the second displaceable holder 132 is provided properly so as to prevent the first displaceable holder 131, the second displaceable holder 132, the first horizontal rolling members 133a and the second horizontal rolling members 133b from loosened, and miniaturization can be achieved.

In FIG. 1A, the carrier 160 is disposed in the containing space, and the imaging lens assembly 11 is mounted on the carrier 160. The carrier 160 includes at least one axial rolling member 161. The axial rolling member 161 is provided that renders the carrier 160 displaceable relatively to the first displaceable holder 131 and the second displaceable holder 132 along a direction parallel to the central axis X. Hence, the axial displaceable degrees of freedom can be provided for achieving three-axis translation of the whole driving device. Moreover, the cover 110 can overlap at least one part of the axial rolling member 161 along the direction parallel to the central axis X. Hence, the cover 110 can prevent the axial rolling member 161 from loosened and remains the carrier 160 displaceable in a specific region.

The driving magnet is disposed on one of the carrier 160, the first displaceable holder 131 and the second displaceable holder 132, and the driving coil is fixed to the cover 110 and corresponding to the driving magnet. Hence, the electromagnetic driving force can be provided for achieving stability of the optical image and auto focusing. Specifically, in the 1 st embodiment, the driving magnet includes a first driving magnet 171 and a second driving magnet 172. A number of each of the first driving magnet 171 and the second driving magnet 172 is two, and the first driving magnets 171 and the second driving magnets 172 can be disposed on the carrier 160 and the second displaceable holder 132, respectively. The driving coil includes at least one first horizontal driving coil 181 and at least one second horizontal driving coil 182. A number of each of the first horizontal driving coil 181 and the second horizontal driving coil 182 is two, and the first horizontal driving coils 181 and the second horizontal driving coils 182 are corresponding to the first driving magnets 171 and the second driving magnets 172, respectively, but the present disclosure is not limited thereto. Hence, the displaceable holder can be driven to move along directions perpendicular to the central axis X. The driving coil can further include at least one axial driving coil 183. A number of the axial driving coil 183 is two and the axial driving coils 183 are fixed on the cover 110 and corresponding to the two first driving magnets 171 which are disposed on the carrier 160. Hence, the carrier 160 can be driven to move along the central axis X.

In the 1 st embodiment, a number of the translational auxiliary member 140 is eight and the translational auxiliary members 140 are cylinders. Four of the translational auxiliary members 140 abut against the first displaceable holder 131 and the cover 110, and the other four of the translational auxiliary members 140 abut against the second displaceable holder 132 and the cover 110. Hence, the stronger structural design can be provided, and the stability of the displaceable direction can be remained. The cover 110 can provide a normal force acting on the first displaceable holder 131, the second displaceable holder 132, the first horizontal rolling members 133a and the second horizontal rolling members 133b via the translational auxiliary member 140, and a direction of the normal force is perpendicular to a displaceable direction of the first displaceable holder 131 and the second displaceable holder 132. Hence, the normal force can keep the first displaceable holder 131, the second displaceable holder 132, the first horizontal rolling members 133a and the second horizontal rolling members 133b remaining on a displaceable surface for stabilizing the displaceable direction.

Furthermore, in the 1 st embodiment, a number of the axial rolling member 161 is eight and the axial rolling members 161 are balls. Each two of the axial rolling members 161 are disposed on the second displaceable holder 132 and corresponding to each two of the translational auxiliary members 140 which abut against the second displaceable holder 132 and the cover 110, and against the first displaceable holder 131 and the cover 110, respectively, but the present disclosure is not limited thereto.

Moreover, the groove 150 is disposed on at least one of the displaceable holder and the cover 110, and the translational auxiliary members 140 are disposed in the groove 150. Specifically, a number of the groove 150 is sixteen, eight of the grooves 150 are disposed on the first displaceable holder 131, another four of the grooves 150 are disposed on the second displaceable holder 132, and the other four of the grooves 150 are disposed on the base 120. Both of the first horizontal rolling members 133a and the second horizontal rolling members 133b are disposed in the grooves 150. Furthermore, the grooves 150 can be disposed on the cover 110 on demand, but the present disclosure is not limited thereto. Hence, the first displaceable holder 131, the second displaceable holder 132 and the cover 110 can be prevented from the strong impact by the translational auxiliary members 140, the first horizontal rolling members 133a and the second horizontal rolling members 133b so as to improve product reliability.

FIG. 10 is a perspective schematic view of the cover 110 according to the 1 st embodiment in FIG. 1A, FIG. 1D is a three-dimensional schematic view of the cover 110 according to the 1 st embodiment in FIG. 1A, and FIG. 1E is another three-dimensional schematic view of the cover 110 according to the 1st embodiment in FIG. 1A. In FIGS. 1B to 1E, the cover 110 includes an opening portion 111, a fixing portion 112 and a receiving portion 113. The opening portion 111 surrounds the central axis X and forms an opening 111a. The fixing portion 112 extends from the opening portion 111 to the base 120 and fixed to the base 120. The receiving portion 113 is disposed between the opening portion 111 and the fixing portion 112, and for receiving the translational auxiliary members 140. Hence, via the design of the receiving portion 113, the structural strength of the cover 110 can be improved and manufacturing tolerance of the cover 110 can be decreased. Moreover, the receiving portion 113 can include two step surfaces 113a, 113b. The two step surfaces 113a, 113b are parallel to each other and receive two of the translational auxiliary members 140. Hence, the stress between the cover 110 and the translational auxiliary members 140 is well-distributed. In detail, the two step surfaces 113a, 113b can be corresponding to two horizontal rolling members which roll along different dimensions, respectively. The receiving portion 113 can receive the translational auxiliary members 140 by a point contacting method. Hence, the friction between the cover 110 and the translational auxiliary members 140 can be reduced so as to improve the driving quality. Furthermore, the fixing portion 112 of the cover 110 can be connected and fixed to the base 120 via glue adhesion or welding, but the present disclosure is not limited thereto.

The cover 110 can further include at least two gate traces 114. Specifically, in the 1 st embodiment, a number of the gate traces 114 are two, but the present disclosure is not limited thereto. Hence, the molding efficiency can be improved and the molding tolerance can be decreased. Moreover, the cover 110 can be made of at least one of plastic material and metal material. In the 1 st embodiment, the cover 110 is a plastic cover with an inserted metal element M. After insert molding, the metal element M is welded at a welding location F, fixed to the base 120 and electrically connected to the driving circuit board 13 so as to drive the current to the axial driving coils 183 disposed on the cover 110. Hence, the cover with high structural strength and high size accuracy can be provided, and the higher producing efficiency can be promoted.

FIG. 1F is a schematic view of parameters of the camera module 10 according to the 1 st embodiment in FIG. 1A. In FIGS. 1A to 1F, the axial rolling members 161 can be closer to the central axis X than the translational auxiliary members 140 to the central axis X. Hence, compactness of the structure can be improved so as to avoid the condition of the unbalanced force during the axial movement. Specifically, a distance between the central axis X and each of the axial rolling members 161 is Da, a distance between the central axis X and each of the translational auxiliary members 140 is Db, and Da can be smaller than Db. In the 1 st embodiment, Da is equal to 7.05 mm, and Db is 8.86 mm and 9.39 mm.

### <2 nd Embodiment>

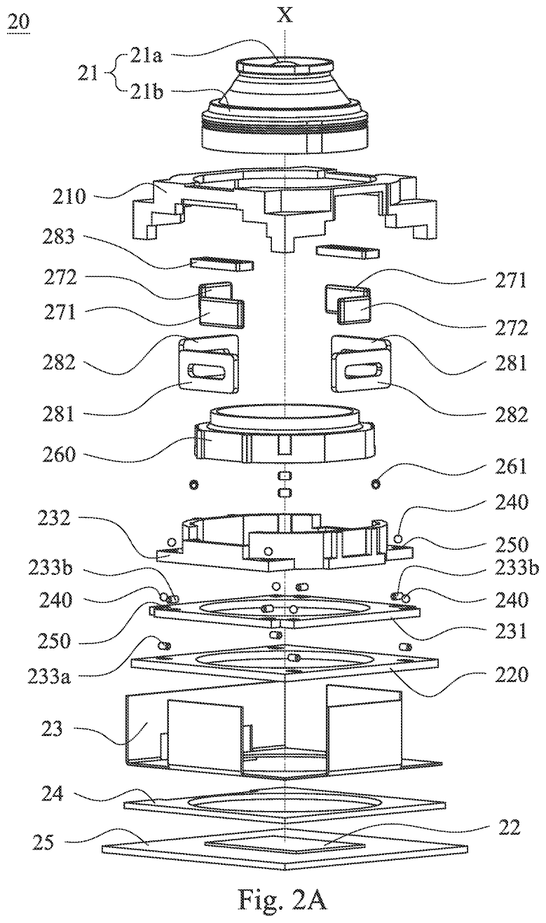

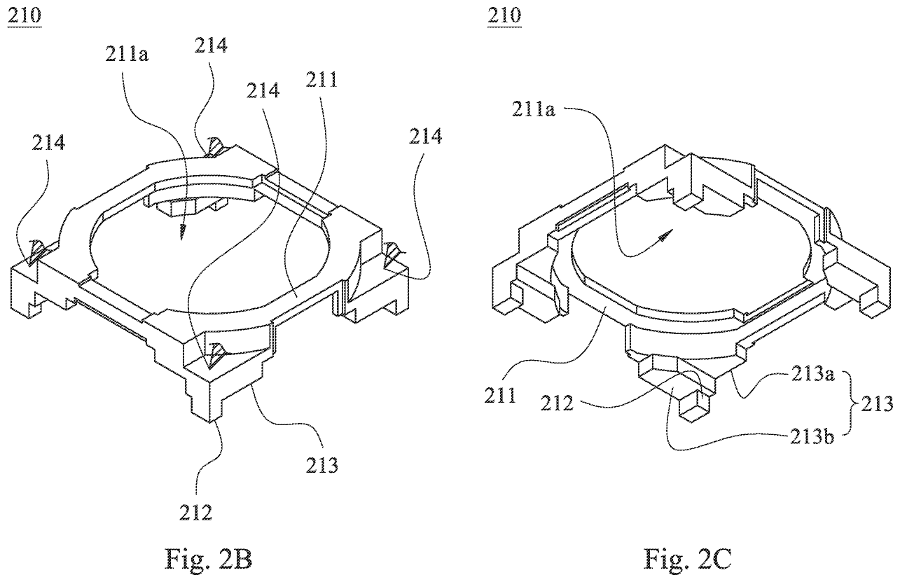

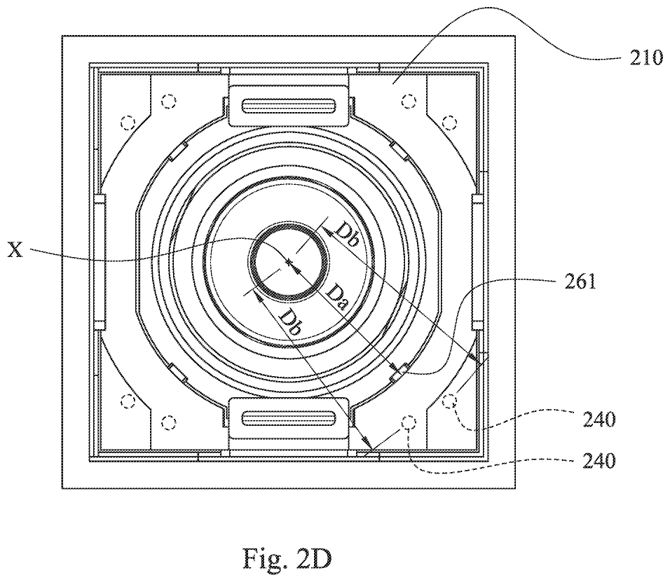

FIG. 2A is an exploded schematic view of a camera module 20 according to the 2 nd embodiment of the present disclosure. In FIG. 2A, the camera module 20 includes a driving device (its numeral reference is omitted), an imaging lens assembly 21, an image sensor 22, a driving circuit board 23, a substrate 24 and a circuit board 25. The image lens assembly 21 is disposed in the driving device. The driving circuit board 23, the substrate 24 and the circuit board 25 are arranged in order from a top to a bottom. The image sensor 22 is disposed on the circuit board 25. The driving device has a central axis X and includes a cover 210, a base 220, at least one displaceable holder (its numeral reference is omitted), at least one translational auxiliary member 240, at least one groove 250, a carrier 260, at least one driving magnet (its numeral reference is omitted) and at least one driving coil (its numeral reference is omitted). The imaging lens assembly 21 includes an imaging lens element set 21a and a lens barrel 21b. The imaging lens element set 21a is disposed in the lens barrel 21b, and the imaging lens assembly 21 is disposed in a containing space (its numeral reference is omitted) formed by the cover 210 and the base 220. In detail, the driving device is provided that renders the imaging lens element set 21a displaceable along a direction perpendicular to the central axis X (that is, an optical axis of the imaging lens assembly 21) and a direction parallel to the central axis X. The image sensor 22 is for converting a light passing through the imaging lens element set 21a into an image signal.

In FIG. 2A, the cover 210 surrounds the central axis X and is fixed to the base 220. The displaceable holder is disposed in the containing space and includes at least one horizontal rolling member (its numeral reference is omitted). The horizontal rolling member is provided that renders the displaceable holder displaceable relatively to the cover 210 and the base 220 along at least one direction perpendicular to the central axis X. The translational auxiliary member 240 abuts against the cover 210 and the displaceable holder. The translational auxiliary member 240 and the horizontal rolling member are disposed on two opposite sides along the central axis X, respectively. Hence, the displaceable degrees of freedom on two-dimensional surface can be provided. Furthermore, tilting during assembling can be prevented via the translational auxiliary member 240 disposed symmetrically along the central axis X. In detail, the displaceable holder can include a first displaceable holder 231 and a second displaceable holder 232, and the horizontal rolling member can include at least one first horizontal rolling member 233a and at least one second horizontal rolling member 233b. A number of the first horizontal rolling member 233a is four, and the first horizontal rolling members 233a are cylinders and disposed between the base 220 and the first displaceable holder 231. A number of the second horizontal rolling member 233b is four, and the second horizontal rolling members 233b are cylinders and disposed between the first displaceable holder 231 and the second displaceable holder 232, but the present disclosure is not limited thereto.

Moreover, the cover 210 can be used to restrict the displaceable region of the first displaceable holder 231 and the second displaceable holder 232. Via the design of the translational auxiliary member 240 and the cover 210, the prepressing against the first displaceable holder 231 and the second displaceable holder 232 is provided properly so as to prevent the first displaceable holder 231, the second displaceable holder 232, the first horizontal rolling members 233a and the second horizontal rolling members 233b from loosened, and miniaturization can be achieved.

In FIG. 2A, the carrier 260 is disposed in the containing space, and the imaging lens assembly 21 is mounted on the carrier 260. The carrier 260 includes at least one axial rolling member 261. The axial rolling member 261 is provided that renders the carrier 260 displaceable relatively to the first displaceable holder 231 and the second displaceable holder 232 along a direction parallel to the central axis X. Hence, the axial displaceable degrees of freedom can be provided for achieving three-axis translation of the whole driving device. Moreover, the cover 210 can overlap at least one part of the axial rolling member 261 along the direction parallel to the central axis X. Hence, the cover 210 can prevent the axial rolling member 261 from loosened and remains the carrier 260 displaceable in a specific region.

The driving magnet is disposed on one of the carrier 260, the first displaceable holder 231 and the second displaceable holder 232, and the driving coil is fixed to the cover 210 and corresponding to the driving magnet. Hence, the electromagnetic driving force can be provided for achieving stability of the optical image and auto focusing. Specifically, the driving magnet includes a first driving magnet 271 and a second driving magnet 272. A number of each of the first driving magnet 271 and the second driving magnet 272 is two, and the first driving magnets 271 and the second driving magnets 272 can be disposed on the carrier 260 and the second displaceable holder 232, respectively. The driving coil includes at least one first horizontal driving coil 281 and at least one second horizontal driving coil 282. A number of each of the first horizontal driving coil 281 and the second horizontal driving coil 282 is two, and the first horizontal driving coils 281 and the second horizontal driving coils 282 are corresponding to the first driving magnets 271 and the second driving magnets 272, respectively, but the present disclosure is not limited thereto. Hence, the displaceable holder can be driven to move along directions perpendicular to the central axis X. The driving coil can further include at least one axial driving coil 283. A number of the axial driving coil 283 is two and the axial driving coils 283 are fixed on the cover 210 and corresponding to the two first driving magnets 271 which are disposed on the carrier 260. Hence, the carrier 260 can be driven to move along the central axis X.

In the 2 nd embodiment, a number of the translational auxiliary member 240 is eight and the translational auxiliary members 240 are balls. Four of the translational auxiliary members 240 abut against the first displaceable holder 231 and the cover 210, and the other four of the translational auxiliary members 240 abut against the second displaceable holder 232 and the cover 210. Hence, it is convenient for assembling easily so as to improve the assembling efficiency. The cover 210 can provide a normal force acting on the first displaceable holder 231, the second displaceable holder 232, the first horizontal rolling members 233a and the second horizontal rolling members 233b via the translational auxiliary member 240, and a direction of the normal force is perpendicular to a displaceable direction of the first displaceable holder 231 and the second displaceable holder 232. Hence, the normal force can keep the first displaceable holder 231, the second displaceable holder 232, the first horizontal rolling members 233a and the second horizontal rolling members 233b remaining on a displaceable surface for stabilizing the displaceable direction.

Furthermore, in the 2 nd embodiment, a number of the axial rolling member 261 is four and the axial rolling members 261 are cylinders. Each of the axial rolling members 261 are disposed on the second displaceable holder 232 and corresponding to each two of the translational auxiliary members 240 which abut against the second displaceable holder 232 and the cover 210, and against the first displaceable holder 231and the cover 210, respectively, but the present disclosure is not limited thereto.

Moreover, the groove 250 is disposed on at least one of the displaceable holder and the cover 210, and the translational auxiliary members 240 are disposed in the groove 250. Specifically, a number of the groove 250 is sixteen, eight of the grooves 250 are disposed on the first displaceable holder 231, another four of the grooves 250 are disposed on the second displaceable holder 232, and the other four of the grooves 250 are disposed on the base 220. Both of the first horizontal rolling members 233a and the second horizontal rolling members 233b are disposed in the grooves 250. Furthermore, the grooves 250 can be disposed on the cover 210 on demand, but the present disclosure is not limited thereto. Hence, the first displaceable holder 231, the second displaceable holder 232 and the cover 210 can be prevented from the strong impact by the translational auxiliary members 240, the first horizontal rolling members 233a and the second horizontal rolling members 233b so as to improve product reliability.

FIG. 2B is a three-dimensional schematic view of the cover 210 according to the 2 nd embodiment in FIG. 2A, and FIG. 2C is another three-dimensional schematic view of the cover 210 according to the 2 nd embodiment in FIG. 2A. In FIGS. 2B and 2C, the cover 210 includes an opening portion 211, a fixing portion 212 and a receiving portion 213. The opening portion 211 surrounds the central axis X and forms an opening 211a. The fixing portion 212 extends from the opening portion 211 to the base 220 and fixed to the base 220. The receiving portion 213 is disposed between the opening portion 211 and the fixing portion 212, and for receiving the translational auxiliary members 240. Hence, via the design of the receiving portion 213, the structural strength of the cover 210 can be improved and manufacturing tolerance of the cover 210 can be decreased. Moreover, the receiving portion 213 can include two step surfaces 213a, 213b. The two step surfaces 213a, 213b are parallel to each other and receive the at least two translational auxiliary members 240. Hence, the stress between the cover 210 and the translational auxiliary members 240 is well-distributed. In detail, the two step surfaces 213a, 213b can be corresponding to two horizontal rolling members which roll along different dimensions, respectively. The receiving portion 213 can receive the translational auxiliary members 240 by a point contacting method. Hence, the friction between the cover 210 and the translational auxiliary members 240 can be reduced so as to improve the driving quality. Furthermore, the fixing portion 212 of the cover 210 can be connected and fixed to the base 220 via glue adhesion or welding, but the present disclosure is not limited thereto.

The cover 210 can further include at least two gate traces 214. Specifically, in the 2 nd embodiment, a number of the gate traces 214 are two, but the present disclosure is not limited thereto. Hence, the molding efficiency can be improved and the molding tolerance can be decreased. Moreover, the cover 210 can be made of at least one of plastic material and metal material. In the 2nd embodiment, the cover 210 is a plastic cover via injection molding and then fixed on the base 220 via glue adhesion. Hence, the cover with high structural strength and high size accuracy can be provided, and the higher producing efficiency can be promoted.

FIG. 2D is a schematic view of parameters of the camera module 20 according to the 2 nd embodiment in FIG. 2A. In FIGS. 2A to 2D, the axial rolling members 261 can be closer to the central axis X than the translational auxiliary members 240 to the central axis X. Hence, compactness of the structure can be improved so as to avoid the condition of the unbalanced force during the axial movement. Specifically, a distance between the central axis X and each of the axial rolling members 261 is Da, a distance between the central axis X and each of the translational auxiliary members 240 is Db, and Da can be smaller than Db. In the 2 nd embodiment, Da is equal to 7.05 mm, and Db is 8.86 mm and 9.39 mm.

### <3 rd Embodiment>

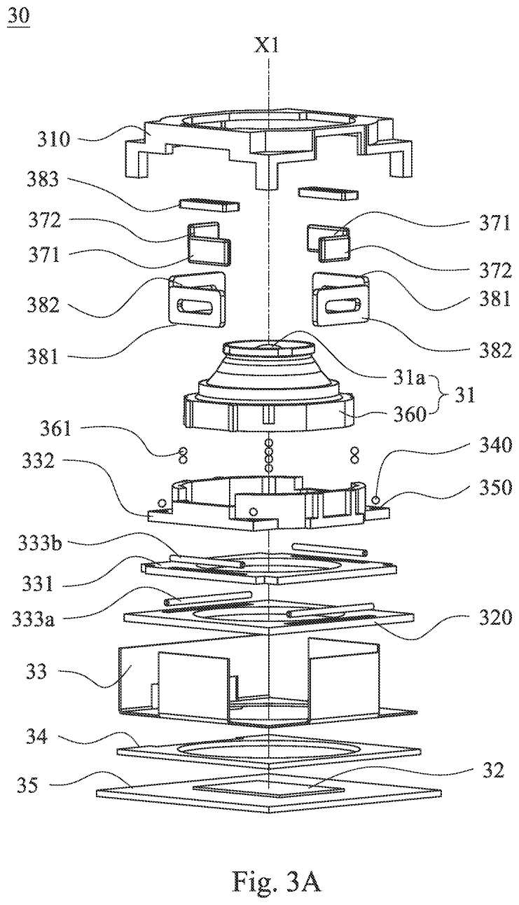

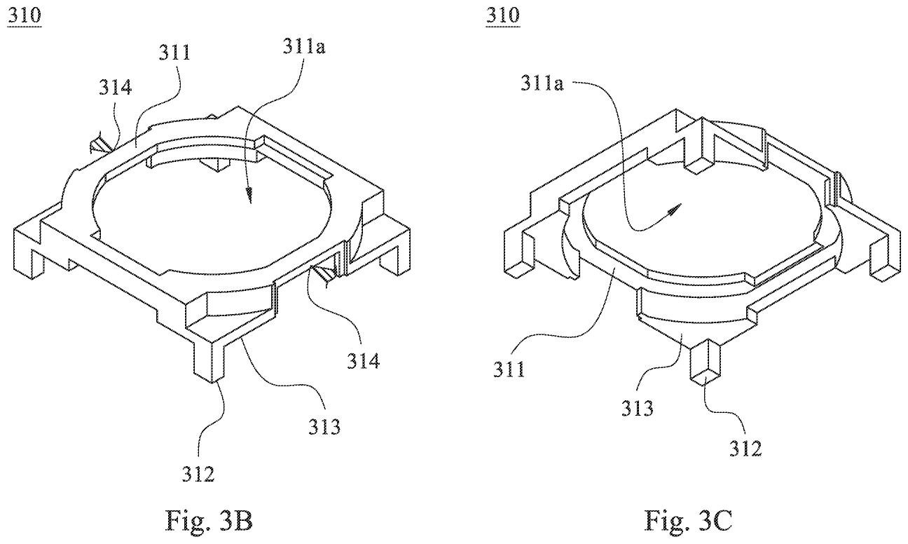

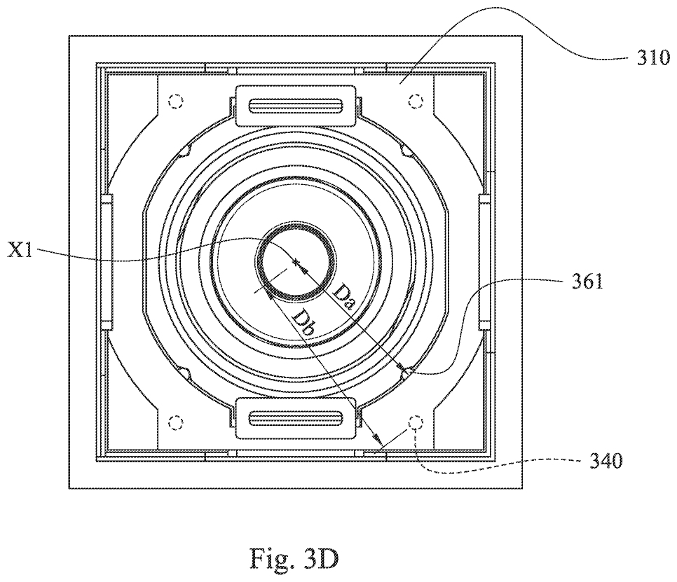

FIG. 3A is an exploded schematic view of a camera module 30 according to the 3 rd embodiment of the present disclosure. In FIG. 3A, the camera module 30 includes a cover 310, a base 320, an imaging lens assembly 31, at least one horizontal rolling member (its numeral reference is omitted), an image sensor 32, a driving circuit board 33, a substrate 34 and a circuit board 35. The driving circuit board 33, the substrate 34 and the circuit board 35 are arranged in order from a top to a bottom. The image sensor 32 is disposed on the circuit board 35. The cover 310 is fixed to the base 320 for forming a containing space (its numeral reference is omitted). The imaging lens assembly 31 is disposed in the containing space and has an optical axis X1. The cover 310 has a central axis (That is, the optical axis X1 of the imaging lens assembly 31). The imaging lens assembly 31 includes an imaging lens element set 31a and a carrier 360. The imaging lens element set 31a is disposed in the carrier 360, and the carrier functions as a lens barrel. That is, the imaging lens assembly 31 is an imaging lens assembly formed integrally. The horizontal rolling member is provided that renders the imaging lens assembly 31 displaceable relatively to the cover 310 and the base 320 along at least one direction perpendicular to the optical axis X1. The cover 310 provides a normal force acting on the horizontal rolling member, and a direction of the normal force is parallel to the optical axis X1 of the imaging lens assembly 31. The image sensor 22 is for converting a light passing through the imaging lens element set 31a into an image signal.

In FIG. 3A, the camera module 30 can further include at least one displaceable holder (its numeral reference is omitted) and at least one translational auxiliary member 340. The displaceable holder is disposed in the containing space. The translational auxiliary member 340 abuts against the cover 310 and the displaceable holder. The translational auxiliary member 340 and the horizontal rolling member are disposed on two opposite sides along the central axis, respectively. Hence, the displaceable degrees of freedom on two-dimensional surface can be provided. Furthermore, tilting during assembling can be prevented via the translational auxiliary member 340 disposed symmetrically along the central axis. In detail, the displaceable holder can include a first displaceable holder 331 and a second displaceable holder 332, and the horizontal rolling member can include at least one first horizontal rolling member 333a and at least one second horizontal rolling member 333b. A number of the first horizontal rolling member 333a is two, and the first horizontal rolling members 333a are cylinders and disposed between the base 320 and the first displaceable holder 331. A number of the second horizontal rolling member 333b is two and the second horizontal rolling members 333b are cylinders and disposed between the first displaceable holder 331 and the second displaceable holder 332, but the present disclosure is not limited thereto.

Moreover, the cover 310 can be used to restrict the displaceable region of the first displaceable holder 331 and the second displaceable holder 332. Via the design of the translational auxiliary member 340 and the cover 310, the prepressing against the first displaceable holder 331 and the second displaceable holder 332 is provided properly so as to prevent the first displaceable holder 331, the second displaceable holder 332, the first horizontal rolling members 333a and the second horizontal rolling members 333b from loosened, and miniaturization can be achieved.

In FIG. 3A, the carrier 360 includes at least one axial rolling member 361. The axial rolling member 361 is provided that renders the carrier 360 displaceable relatively to the first displaceable holder 331 and the second displaceable holder 332 along a direction parallel to the central axis. Hence, the axial displaceable degrees of freedom can be provided for achieving three-axis translation of the whole camera module 30 during auto focusing. Moreover, the cover 310 can overlap at least one part of the axial rolling member 361 along the direction parallel to the central axis. Hence, the cover 310 can prevent the axial rolling member 361 from loosened and remains the carrier 360 displaceable in a specific region.

The camera module 30 can further include at least one driving magnet 371, at least one driving magnet 372, at least one first horizontal driving coil 381 and at least one second horizontal driving coil 382. A number of each of the first driving magnet 371 and the second driving magnet 372 is two, and the first driving magnets 371 and the second driving magnets 372 can be disposed on the carrier 360 and the second displaceable holder 332, respectively. A number of each of the first horizontal driving coil 381 and the second horizontal driving coil 382 is two, and the first horizontal driving coils 381 and the second horizontal driving coils 382 are corresponding to the first driving magnets 371 and the second driving magnets 372, respectively, but the present disclosure is not limited thereto. Hence, the electromagnetic driving force can be provided for achieving stability of the optical image and auto focusing.

The camera module 30 can further include at least one axial driving coil 383. A number of the axial driving coil 383 is two and the axial driving coils 383 are fixed on the cover 310 and corresponding to the first driving magnets 371 which are disposed on the carrier 360. Hence, the carrier 360 can be driven to move along the central axis.

In the 3 rd embodiment, a number of the translational auxiliary member 340 is four and the translational auxiliary members 340 are balls. All of the four translational auxiliary members 340 are disposed on the second displaceable holder 332 and abut against the cover 310. Hence, it is convenient for assembling so as to improve the assembling efficiency. The cover 310 can provide the normal force acting on the first displaceable holder 331, the second displaceable holder 332, the first horizontal rolling members 333a and the second horizontal rolling members 333b via the translational auxiliary member 340, and a direction of the normal force is perpendicular to a displaceable direction of the first displaceable holder 331 and the second displaceable holder 332. Hence, the normal force can keep the first displaceable holder 331, the second displaceable holder 332, the first horizontal rolling members 333a and the second horizontal rolling members 333b remaining on a displaceable surface for stabilizing the displaceable direction.

Furthermore, in the 3 rd embodiment, a number of the axial rolling member 361 is eight and the axial rolling members 361 are balls. Each two of the axial rolling members 361 are disposed on the second displaceable holder 332 and corresponding to each of the translational auxiliary members 340 respectively, but the present disclosure is not limited thereto.

Moreover, the camera module 30 can further include at least one groove 350. The groove 350 is disposed on at least one of the displaceable holder and the cover 310, and the translational auxiliary members 340 are disposed in the groove 350. Specifically, a number of the groove 350 is eight, two of the grooves 350 are disposed on the first displaceable holder 331, another four of the grooves 350 are disposed on the second displaceable holder 332, and the other two of the grooves 350 are disposed on the base 320. Both of the first horizontal rolling members 333a and the second horizontal rolling members 333b are disposed in the grooves 350. Furthermore, the grooves 350 can be disposed on the cover 310 on demand, but the present disclosure is not limited thereto. Hence, the first displaceable holder 331, the second displaceable holder 332 and the cover 310 can be prevented from the strong impact by the translational auxiliary members 340, the first horizontal rolling members 333a and the second horizontal rolling members 333b so as to improve product reliability.

FIG. 3B is a three-dimensional schematic view of the cover 310 according to the 3 rd embodiment in FIG. 3A, and FIG. 3C is another three-dimensional schematic view of the cover 310 according to the 3 rd embodiment in FIG. 3A. In FIGS. 3B and 3C, the cover 310 includes an opening portion 311, a fixing portion 312 and a receiving portion 313. The opening portion 311 surrounds the central axis and forms an opening 311a. The fixing portion 312 extends from the opening portion 311 to the base 320 and fixed to the base 320. The receiving portion 313 is disposed between the opening portion 311 and the fixing portion 312, and for receiving the translational auxiliary members 340. Hence, via the design of the receiving portion 313, the structural strength of the cover 310 can be improved and manufacturing tolerance of the cover 310 can be decreased. Hence, the stress between the cover 310 and the translational auxiliary members 340 is well-distributed. In detail, the receiving portion 313 can receive the translational auxiliary members 340 by a point contacting method. Hence, the friction between the cover 310 and the translational auxiliary members 340 can be reduced so as to improve the driving quality.

The cover 310 can further include at least two gate traces 314. Specifically, in the 3 rd embodiment, a number of the gate traces 314 are two, but the present disclosure is not limited thereto. Hence, the molding efficiency can be improved and the molding tolerance can be decreased. In detail, the fixing portion 312 of the cover 310 can be connected and fixed to the base 320 via glue adhesion or welding, but the present disclosure is not limited thereto. Moreover, the cover 310 can be made of at least one of plastic material and metal material. In the 3 rd embodiment, the cover 310 is a metal cover via stamping molding and then fixed on the base 320 via glue adhesion. Hence, the cover with high structural strength and high size accuracy can be provided, and the higher producing efficiency can be promoted.

FIG. 3D is a schematic view of parameters of the camera module 30 according to the 3 rd embodiment in FIG. 3A. In FIGS. 3A to 3D, the axial rolling members 361 can be closer to the central axis (That is, the optical axis X1 of the image lens assembly 31) than the translational auxiliary members 340 to the central axis. Hence, compactness of the structure can be improved so as to avoid the condition of the unbalanced force during the axial movement. Specifically, a distance between the central axis and each of the axial rolling members 361 is Da, a distance between the central axis and each of the translational auxiliary members 340 is Db, and Da can be smaller than Db. In the 3 rd embodiment, Da is equal to 7.05 mm, and Db is 8.86 mm.

<4 th embodiment>

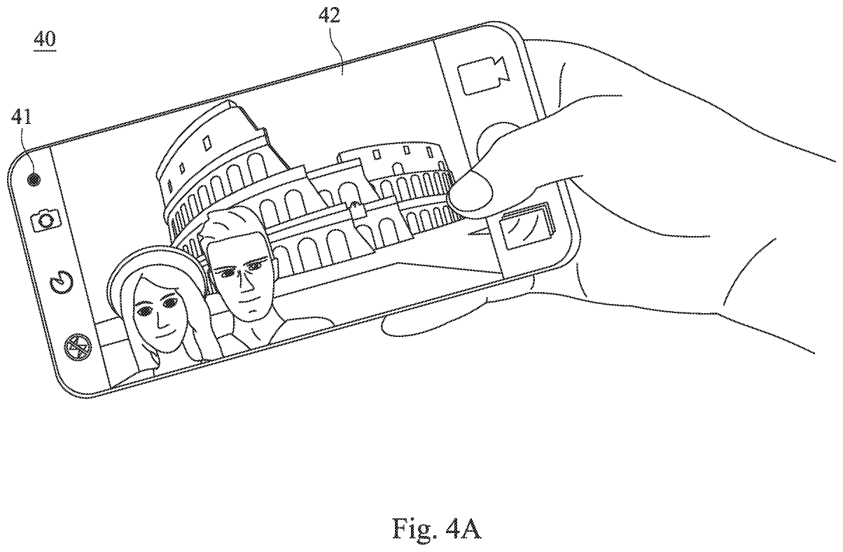

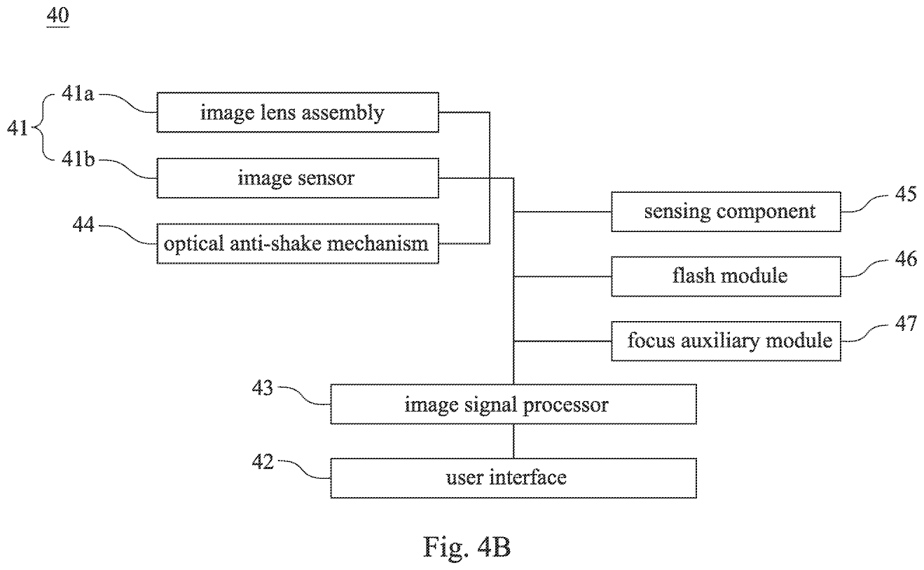

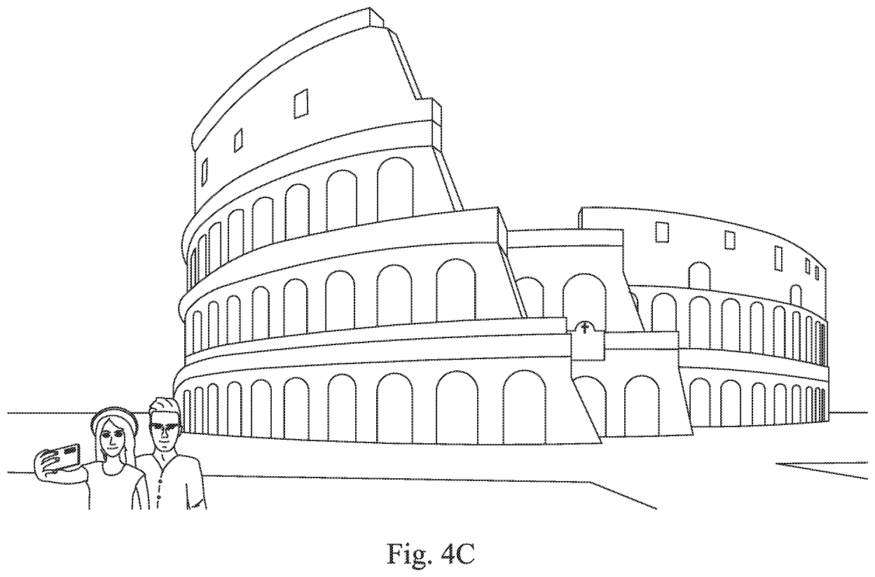

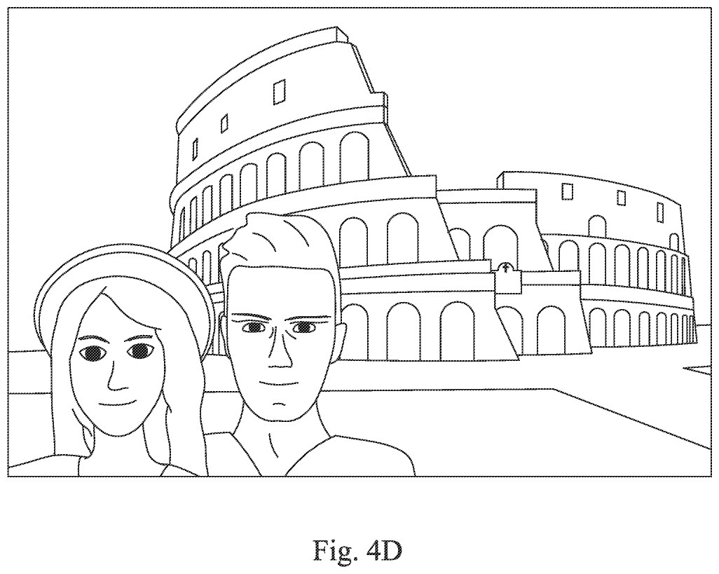

FIG. 4A is a schematic view of an electronic device 40 according to the 4 th embodiment of the present disclosure. FIG. 4B is a block diagram of the electronic device 40 according to the 4 th embodiment in FIG. 4A. In FIGS. 4A and 4B, the electronic device 40 is a smartphone and includes a camera module 41, and a user interface 42. The camera module 41 includes an image lens assembly 41a and an image sensor 41b. The camera module 41 of the 4 th embodiment is disposed on a side region of the user interface 42, and the image sensor 41b is disposed on an image surface (not shown) of the image lens assembly 41a, wherein the user interface 42 can be a touch screen or a display screen, and the present disclosure is not limited thereto. The camera module 41 can be any one according to the 1 st embodiment to the 3 rd embodiment, but the present disclosure is not limited thereto.

Furthermore, the user can activate the capturing mode by the user interface 42 of the electronic device 40. At this moment, the camera module 41 collects imaging light on the image sensor 41b and outputs electronic signals associated with images to an image signal processor (ISP) 43.

In response to the camera specification of the electronic device 40, the electronic device 40 can further include an optical anti-shake mechanism 44, which can be an optical image stabilization (OIS) device. Moreover, the electronic device 40 can further include at least one auxiliary optical component (reference number is omitted) and at least one sensing component 45. In the 4th embodiment, the auxiliary optical component is a flash module 46 and a focus auxiliary module 47, the flash module 46 is for compensating the color temperature, and the focus auxiliary module 47 can be an infrared distance measurement component, a laser focus module, etc. The sensing component 45 can have functions for sensing physical momentum and kinetic energies, such as an accelerator, a gyroscope, and a Hall effect element, so as to sense shaking or jitters applied by hands of the user or external environments. Thus, the autofocus function and the optical anti-shake mechanism 44 of the camera module 41 disposed on the electronic device 40 can function to obtain great image quality and facilitate the electronic device 40 according to the present disclosure to have a capturing function with multiple modes, such as taking optimized selfies, high dynamic range (HDR) with a low light source, 4K resolution recording, etc. Furthermore, the user can visually see the captured image of the camera through the touch screen and manually operate the view finding range on the touch screen to achieve the auto focus function of what you see is what you get.

Furthermore, the electronic device 40 can further include, but not be limited to, a display, a control unit, a storage unit, a random-access memory (RAM), a read-only memory (ROM), or the combination thereof.

FIG. 4C is a schematic view of a selfies scene according to the 4 th embodiment in FIG. 4A. FIG. 4D is a schematic view of an image according to the 4 th embodiment in FIG. 4A. In FIGS. 4A to 4D, both of the camera module 41 and the user interface 42 are faced to the user. When the selfie mode or the live streaming mode is activated, the user can simultaneously see the captured image and operate the user interface 42. After shooting, the captured image as shown in FIG. 4D can be obtained. Therefore, the camera module 41 of the present disclosure can provide a better shooting experience.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A driving device, having a central axis, the driving device comprising:
a cover surrounding the central axis;
a base, the cover fixed to the base for forming a containing space;
at least one displaceable holder disposed in the containing space, the at least one displaceable holder comprising at least one horizontal rolling member, the at least one horizontal rolling member provided that renders the at least one displaceable holder displaceable relatively to the cover and the base along at least one direction perpendicular to the central axis; and
at least one translational auxiliary member abutting against the cover and the at least one displaceable holder;
wherein the at least one translational auxiliary member and the at least one horizontal rolling member are disposed on two opposite sides along the central axis, respectively.

2. The driving device of claim 1, wherein the cover provides a normal force acting on the at least one displaceable holder and the at least one horizontal rolling member via the at least one translational auxiliary member, and a direction of the normal force is perpendicular to a displaceable direction of the at least one displaceable holder.

3. The driving device of claim 1, wherein the cover comprises:
an opening portion surrounding the central axis and forming an opening;
a fixing portion extending from the opening portion to the base and fixed to the base; and
a receiving portion disposed between the opening portion and the fixing portion, and for receiving the at least one translational auxiliary member.

4. The driving device of claim 3, wherein the receiving portion comprises two step surfaces, the two step surfaces are parallel to each other and receive two of the at least one translational auxiliary member.

5. The driving device of claim 3, wherein the receiving portion receives the at least one translational auxiliary member by a point contacting method.

6. The driving device of claim 1, further comprising:
at least one groove disposed on at least one of the at least one displaceable holder and the cover, and the at least one translational auxiliary member disposed in the at least one groove.

7. The driving device of claim 1, wherein the at least one translational auxiliary member is a ball.

8. The driving device of claim 1, wherein the at least one translational auxiliary member is a cylinder.

9. The driving device of claim 1, wherein the at least one translational auxiliary member is disposed symmetrically along the central axis.

10. The driving device of claim 1, further comprising:
a carrier disposed in the containing space, the carrier comprising at least one axial rolling member, wherein the at least one axial rolling member is provided that renders the carrier displaceable relatively to the at least one displaceable holder along a direction parallel to the central axis.

11. The driving device of claim 10, wherein the cover overlaps at least one part of the at least one axial rolling member along the direction parallel to the central axis.

12. The driving device of claim 10, wherein the at least one axial rolling member is closer to the central axis than the at least one translational auxiliary member to the central axis.

13. The driving device of claim 1, wherein the cover is made of at least one of plastic material and metal material.

14. The driving device of claim 13, wherein the cover comprises at least two gate traces.

15. The driving device of claim 1, further comprising:
at least one driving magnet disposed on one of a carrier and the at least one displaceable holder; and
at least one driving coil fixed to the cover, and corresponding to the at least one driving magnet.

16. A camera module, comprising:
the driving device of claim 1;
an imaging lens element set disposed on the driving device, the driving device provided that renders the imaging lens element set displaceable along a direction perpendicular to the central axis and a direction parallel to the central axis; and
an image sensor for converting a light passing through the imaging lens element set into an image signal.

17. An electronic device, comprising:
at least one of the camera module of claim 16.

18. A camera module, comprising:
a cover;
a base, the cover fixed to the base for forming a containing space;
an imaging lens assembly disposed in the containing space, and having an optical axis; and
at least one horizontal rolling member disposed between the imaging lens assembly and the base, the at least one horizontal rolling member provided that renders the imaging lens assembly displaceable relatively to the cover and the base along at least one direction perpendicular to the central axis;
wherein the cover provides a normal force acting on the at least one horizontal rolling member, and a direction of the normal force is parallel to the optical axis of the imaging lens assembly.
